(19) United States
(12) Patent Application Publication
(10) Pub. No.: US 2023/0314666 A1
(43) Pub. Date: Oct. 5, 2023

(54) Microlens Array Formation and Alignment

(71) Applicant: Fathom Radiant, PBC, Boulder, CO (US)

(72) Inventors: Omer Tzang, Louisville, CO (US); Keith Behrman, Boulder, CO (US); Kaia Williams, Denver, CO (US); Benjamin Braker, Louisville, CO (US); Robert T. Weverka, Boulder, CO (US); Charles Anderson, Louisville, CO (US); Elizabeth Strong, Boulder, CO (US)

(21) Appl. No.: 18/130,802

(22) Filed: Apr. 4, 2023

Related U.S. Application Data
(60) Provisional application No. 63/327,533, filed on Apr. 5, 2022.

(51) Int. Cl. G02B 3/00; G02B 27/32

(52) U.S. Cl. CPC G02B 3/0075; G02B 3/0056; G02B 27/32; G02B 5/201

(57) ABSTRACT

Microlens array formation and alignment to heterogeneously integrated optoelectronic devices. Optoelectronic devices are printed or transferred in a single process step while also creating inactive optoelectronic devices that are precisely shaped for alignment purposes rather than for optical or electrical performance. Microlenses are integrated monolithically. The microlenses are aligned directly to a fiducial generated by the device integration step, reducing overall misalignment. Additionally, we use specific optical designs for the lenses to add novel functionalities to the system. By designing the lenses with engineered offsets, distances and curvatures with respect to the arrays of optoelectronic devices, we control properties of light such as: angles, phase, beam widths, and wavelength dependence.

This application claims the benefit of U.S. Patent Application 63/327,533, filed 5 Apr. 2022 and incorporates it herein by reference.

### BACKGROUND OF THE INVENTION

### Field of the Invention

The present invention relates to microlens array formation and alignment. In particular, the present invention relates to apparatus and methods for microlens array formation and alignment to heterogeneously integrated optoelectronic devices. Additionally the invention relates to the optical design of the lens array and the functionalities it allows.

### Discussion of Related Art

Microlens elements enable light collimation and manipulation to and from optoelectronic devices. Microlens elements coupled directly to optoelectronic devices are often formed externally and mechanically mounted with glues or adhesives. These lenses are typically much larger than the 10 to 150 μm microlens scale needed for many applications. Because of this, it is challenging to create and attach lenses to densely packed arrays of devices. Other microlens structures, such as those used in camera image sensors, are limited in lens shape and size by the monolithic etching techniques used.

For micro-sized optoelectronics such as micro light-emitting diodes (microLEDs), micro vertical-cavity surface-emitting lasers (microVCSELs), and micro photodetectors (microPDs) where micro is typically defined as an individual device or chiplet with an active-region side dimension of less than 50 μm, additional integration and alignment challenges are introduced. For micro-optics systems that are manipulating single spatial mode beams, a single micron of misalignment can result in large optical losses between elements.

### SUMMARY OF THE INVENTION

Embodiments include arrays of optoelectronics devices with lenses monolithically integrated to the substrate and devices. Imprinting, molding, patterning, or otherwise forming a lens directly to the substrate gives precise control of the lens shape and propagation distance from the optoelectronics to the lens. By using wafer-level techniques, it is also possible to form all lenses across thousands or millions of optoelectronics devices at once.

Additionally, specific optical designs for the lenses add novel functionalities to the system. By designing the lenses with engineered offsets, distances and curvatures with respect to the arrays of optoelectronic devices, properties of light such as: angles, phase, beam widths, and wavelength dependence can be controlled. These designs are made specifically for micron size apertures, beams, and micro-optical systems and allow better signal performance and significant noise reduction.

A device has a substrate, an interleaved array of optical emitters and optical detectors electrically connected to the substrate, and an array of microlenses disposed above the interleaved array and monolithically integrated to the substrate such that a microlens corresponds to each emitter and each detector. Optical emitters in a row have a a wavelength distinct from the wavelengths of optical emitters in other rows.

In some cases, the axis of each microlens is offset from its corresponding optical emitter or optical detector. The entire array of microlenses and the element array may be configured such that the offsets are within a range, such as 4.3 and 4.7 um when the microlens focal lengths are between 98 and 102 um and wherein waist of beams from the optical emitters is between 2.5 and 4 um. Optical emitters within a row may have emission wavelengths separated by 8 to 12 nm from emission wavelengths of optical emitters in an adjacent row.

Standoffs are manufactured in a wafer level processes, and are configured to orient additional optical systems. An array of spatial filters corresponds to detectors in the interleaved array, wherein the detectors have sizes between 20-30 um and the spatial filters have sizes of 30-50 ums. The standoffs have sizes between 5-10 um, and are configured to assemble a second layer of optics adjacent.

A device for delivering light includes a microlens and a VCSEL offset from a center of the microlens. The delivers a substantially flat wavefront, with a desired waist size and location, and at a desired angle. For example, the offset is between 4.3 and 4.7 um when a focal length of the microlens is between 98 and 102 um and wherein the waist size is between 16 and 14 um.

The microlenses may have spherical surfaces. The VCSEL may be a single mode emitter. The device delivers a substantially flat wavefront, with a desired waist size and location, and at a desired angle. Multiple VCSELs within the device may have wavelengths separated by 8 nm or more. The wavefront waist may be placed at a vertex of the microlens or 10-20 um behind a vertex of the microlens.

The microlens can have chromatic properties configured to emit multiple wavelengths, and to filter out undesired wavelengths.

A system for emission of light to and collection of light from an optical system has optical elements including at least two optical emitters and two photodetectors. A microlens corresponds to each optical element, and the microlenses are offset from the elements. In one example, the offsets are between 4.3 and 4.7 um, the microlenses have a focal length between 98 and 102 um and the waists of the beams emitted by the microlenses are between 16 and 14 um.

There are a number of variations. For example, the microlenses have a spherical surface. The emitters are single mode emitters. The emitters emit light with wavelengths separated by 8 or more nm from each other. The emitters are operated simultaneously by a transceiver circuit and light from the emitters travels down a single optical fiber. Light from a second single optical fiber illuminates the photodetectors, which are configured to send electronic signals configured to be received by one or more transceiver circuits. Spatial filter configured to block light may be placed at various points within the system.

### BRIEF DESCRIPTION OF THE DRAWINGS

FIG. 1 is a schematic diagram showing a cross sectional image of an array of optoelectronic devices with lenses monolithically integrated to the substrate and devices.

FIGS. 2A-2E are schematic diagrams showing functionalities of emitter systems with microlenses. FIGS. 2F-2J are schematic diagrams showing functionalities of detector systems with microlenses.

FIG. 3 is a diagram showing an array of interleaved detectors and emitters with integrated microlenses.

### DETAILED DESCRIPTION OF THE INVENTION

For applications such as displays, communication, imaging, and sensing, it is desirable to integrate microlenses directly to optoelectronic devices to maximize the amount of light coupled in and out of the device to the desired medium. Directly coupled microlenses also enable precise manipulation of collimated beams to prevent optical crosstalk.

Imprinting, molding, or patterning lenses directly to the substrate gives precise control of the lens shape and propagation distance from the optoelectronics to the lens. By using wafer-level fabrication techniques, it is also possible to form all lenses across billions of optoelectronics devices at once.

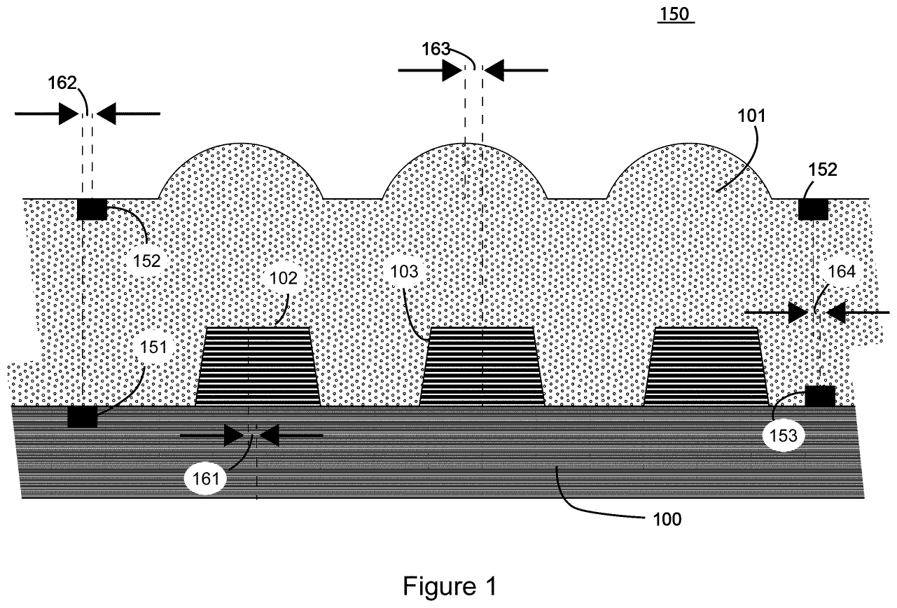

FIG. 1 shows a cross sectional image of an array of optoelectronics devices 102, 103 with lenses 101 monolithically integrated to the substrate 100 and devices, all forming device 150. Optoelectronic devices heterogeneously integrated by mass-transfer printing, die-bonding, flip-chip bonding, or similar, to a non-native substrate 100 will be attached with some alignment error in relation to Fiducial 151 (Distance 161). In a typical alignment scenario, microlenses 101 formed by a molding, imprint, or lithographic process directly to the substrate 100 would experience a secondary misalignment from Fiducials 151 and 152 (Distance 162). The resulting misalignment from the optical center of the optoelectronic device and the lens center (Distance 163) will then result in a root-sum square of misalignments 161 and 162.

In this embodiment, if all optoelectronic devices 102, 103 are printed or transferred in a single process step, it is possible to create an inactive optoelectronic device 150 that is precisely shaped for alignment purposes rather than for optical or electrical performance. This is represented by Fiducial 153 and maintains good alignment with the array of optoelectronic devices through lithographic alignment. The microlenses 101 can then be aligned directly to this fiducial 153, removing the misalignment of Distance 163 from the alignment stack. In this case, alignment Distance 164 will be equivalent to Distance 162 and Distance 163 while negating any effect of alignment Distance 161.

This configuration provides a number of advantages.
Microlenses 101 imprinted directly to emissive optoelectronic elements 102 allows for beam expansion and collimation of the wavefront.
Microlenses 101 imprinted directly to detecting optoelectronic elements 103 allows for focusing of larger beams onto a small detection area.
Improved alignment of microlenses 101 to heterogeneously integrated devices 102, 103 provides the ability to build integrated devices 150 with precise optoelectronic device-to-lens offsets and lens curvatures.
Fabrication of lenses 101 with a precise propagation distance to carefully control beam expansion.
Printing of alignment fiducials 153 alongside optoelectronic devices 102, 103 reduces misalignment stacking.
Allows densely packing lens elements 101 to optoelectronic arrays.

In the embodiments below we describe various innovative functionalities using micro lens optical designs.

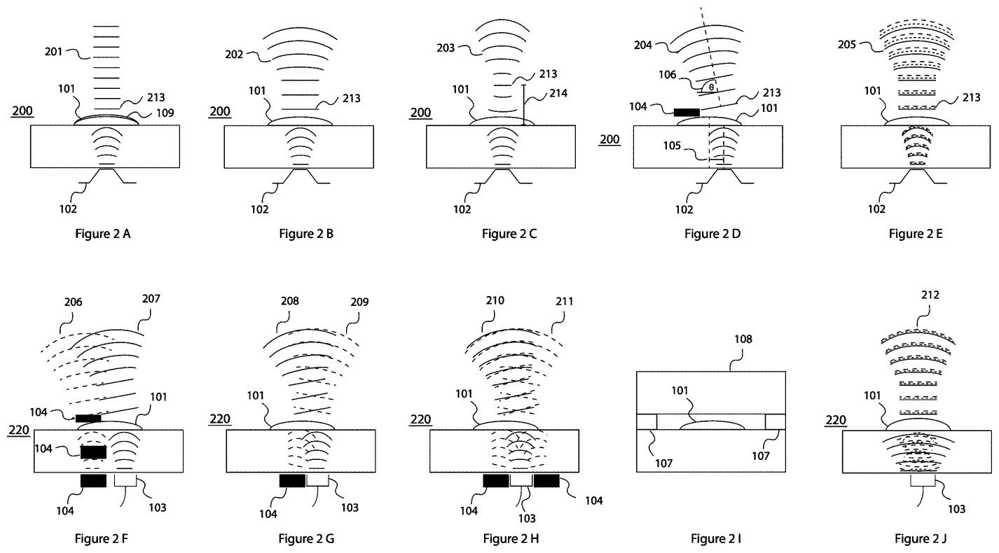

FIGS. 2A-2E are side schematic views illustrating emitter devices 200 having emitters 102 and microlenses 101. Optical system 108 (FIG. 2I) uses the microlens 101 to define a beam size (213, FIG. 2A), a wavefront (201, FIG. 2B), and an angle (106, FIG. 2D) at desired locations above the lens.

In some embodiments, opaque aperture stops 104 are added within the microlens stack 150. By using wafer level spin-coating and lithographic patterning techniques, a microlens stack 150 can be formed that contains apertures in prescribed locations. FIGS. 2D, 2F, 2G, and 2H show that the aperture stops 104 can be fabricated on top of the silicon 100 (FIGS. 2F, 2G, 2H), inside the lens 101 structure (FIG. 2F), or on top of the lens (FIGS. 2D, 2F). These fabrication methods enable precise beam shaping and masking properties to reduce noise, cross-talk, and increase contrast of the optical system.

The VCSEL's 102 aperture size may have a mode field diameter of 3 to 6 microns. Due to this small dimension, the beam emitted from the VCSEL 102 is diverging relatively fast (202, FIG. 2B) and in a preferred embodiment said beam is substantially a single spatial mode. Other embodiments may work with emitters which emit with multiple modes. It is useful to collimate the beam or decrease its divergence angle for further manipulation in the optics above. The microlens is therefore designed to allow a precise propagation distance to set a beam size and substantially flat phase wavefront (213), of less than tenth of a wavelength, at a plane located either on the vertex of the lens (FIG. 2B) or at a distance 214 from the vertex of the lens 203 (FIG. 2C).

In an ideal case, the substantially flat wavefront 213 has a phase which is exactly constant across a planar surface normal to the direction of propagation. In said ideal case, the linear fit of the wavefront exactly determines the direction of propagation. And, as a corollary, the plane normal to the direction of propagation defines the wavefront. In practice, substantially flat wavefronts may vary from the ideal, provided the deviations are less than about ⅕ wavelength in size. In one embodiment, the wavefront may have substantial third order deviations from the planar fit. In one embodiment, the wavefront may exhibit astigmatism.

In one embodiment, the wavefront may exhibit chromatic aberrations. In one embodiment, the wavefront may exhibit coma. One key feature of the invention may include a lens offset 105 with respect to the VCSEL to inject a defined angle 106 into the optical system 108. At an interface to the optical system, the angle of incidence is defined as the angle between the direction of propagation and the coordinates of the optical system. The angle of incidence at the microlens may be defined as the angle of departure from the microlens with respect to the surface of the microlenses. In this invention, we deliver methods which control said angle to within 0.1 degrees or better. The small size of both the lens and the beam, typically 3 to 50 microns, require micron scale simulation and calculation for these lenses.

In a preferred embodiment, the microlens 101 has a focal length of (98 to 102 um), the offset 105 is 4.3 to 4.7 um, and the angles 106 are 2.87±0.1 degrees. This level of precision benefits from wafer level alignment using lithographic methods with tight tolerances.

In another embodiment, we mitigate the chromatic effect of various wavelengths by calculating the wavelength-dependent wavefronts and designing surfaces that minimize errors across desired wavelength ranges, typically between 800 nm and 1100 nm (205). This allows us to build a uniform array of microlenses 101 with two or more emitters 102 producing two or more wavelengths of light. We highlight this embodiment since a uniform array is more affordable and manufacturable at scale.

FIGS. 2F-2J are schematic diagrams showing functionalities of detector systems with microlenses. The property of the microlens 101 can spatially filter light into a detector 103. By setting lenses in front detectors on the chip (not shown), we can focus 207 light from the optical system down to the detector (103, FIG. 2F)) and reject undesired stray light, including light from different positions, or sources (206, FIG. 2F), light from different angles (209, FIG. 2G), reflections or direction of propagation (211, FIG. 2H). We highlight the filtering properties of the microlens to reject scattered light and stray light, increasing the SNR of our system. Spatial filters may be used as aperture stops 104 on top of the detector 103 or Vcsel 102 surface (FIGS. 2F, and 2H), at the top of the microlens (FIGS. 2D and 2F), or inside the lens (FIG. 2F) to ensure that rejected light is absorbed.

In some embodiments, lens 101 utilizes the chromatic effect of various wavelengths by configuring lens 101 to focus only a narrow wavelength band of light to a detector 103 while defocusing and hence decreasing the detected light at other wavelengths (212, FIG. 2J). A preferred embodiment uses a 20 micron detector 103 and rejects wavelengths that are 100 to 200 nm away from the desired wavelength.

In another embodiment shown in FIG. 2I, we use standoffs 107 on the microlens array 100 to precisely align additional optics 108 on top of this array. This embodiment allows wafer level alignment and assembly of additional optics 108 above the emitters 102. We may use fiducials 153 or other passive and active alignment methodologies for this process.

In another embodiment we design the microlenses using various non-refractive lens technologies. Microlenses may be fabricated on a surface using metalens technology or diffractive optics designs. Those lenses may be lithographically defined on a surface with a defined thickness. Microlenses may be fabricated by modifying the refractive index of the surface using graded index (GRIN) lenses, or thermal lenses.

FIGS. 2A-J show examples of microlenses and functionalities enabled. A laser beam is emitted from an emitter 102, we plot the wavefront curvature of the beam, as it propagates out of the emitters with a diverging spherical wavefront 202. The microlens 101 collimates the light, turning the wavefront to a plane wave with parallel wavefronts (201, FIG. 2A). Such a beam has a defined size which is maintained with further propagation. If the beam size is small enough, the beam keeps diverging after the microlens, but at a slower rate (202, FIG. 2B). The beam can also be further focused to shift the waist of the beam to a defined plane after the lens, e.g. at a distance of 10-20 um from the lens (203, FIG. 2C). This plane defines a beam waist and a flat wavefront. In FIG. 2D, offset of the emitter 102 with respect to the lens 101 can generate an angle after the lens 106 which may be important for applications in the optical system above.

FIG. 2E shows that the chromatic properties of the lens are configured to emit multiple wavelengths efficiently. Multiwavelength emission 205 from emitters 102 can cause errors in wavefronts and beam waists. Microlenses 101 can minimize these effects by designing for either an average wavelength or calculating a lens shape that minimizes overall error in the wavefront.

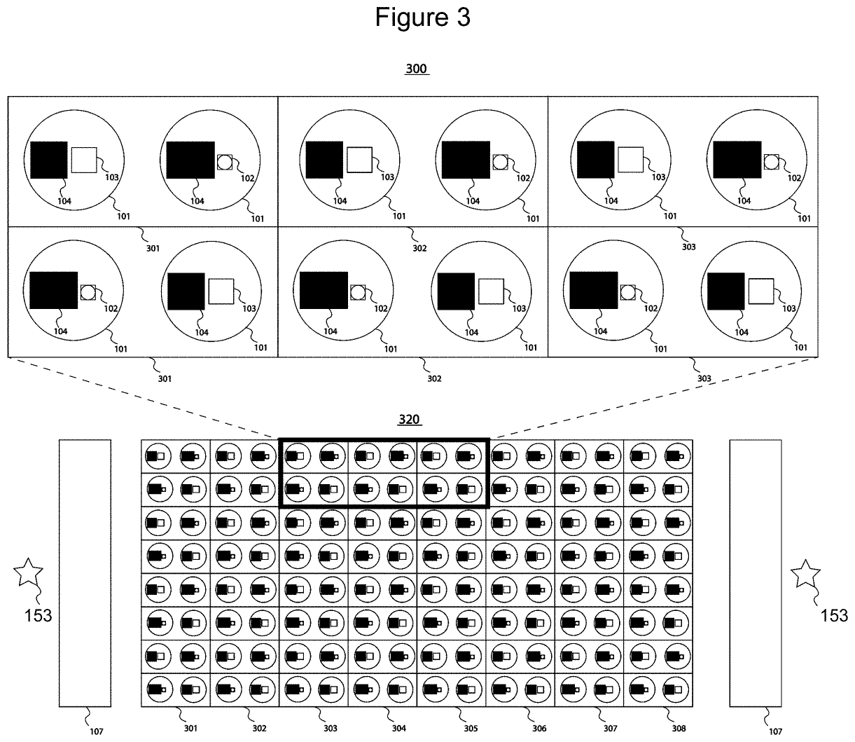

FIG. 3 shows a device 320 having a 2D array of pairs 301-308 of emitters 102 and detectors 103, with spatial filters 104. In one embodiment of said array, the emitters placed within each of the eight rows (or columns) has a different wavelength than the emitters placed in the other rows (or columns). There are offsets 107 and fiducial marks 153. This example is designed for eight wavelengths. In other embodiments, the array may be designed for 16 or more wavelengths. A portion 300 of array 320 is magnified above.

In a preferred embodiment, a microlens 101 is placed above each of the emitters/detectors at an offset, as in FIG. 2D. Each pair 301-308 of VCSELs 102 and detectors 103 along with spatial filters 204 is designed for a specific wavelength. In the example of FIG. 3, each column is interleaved, such that a detector is placed below a VCSEL. In this example the columns are configured so that a detector is placed next to an emitter as well. In other embodiments, the arrangement may be uniform at each column or heterogeneous changes within a period for each row/column, or non-periodical.

The assembly process of the heterogeneous array 150, 320 of interleaved emitters and detectors onto a silicon electronics substrate may use a microassembly packaging process such as mass-transfer printing. In one variation of said embodiment of interleaved emitters and detectors, emitters at one wavelength may be placed in one row of the interleave pattern and emitters at a second wavelength may be placed in a different row of the interleave pattern. In said variation, emitters at the first wavelength may be placed during one step of the mass-transfer printing process and emitters at the second wavelength may be placed during a different step. In said variation, the microlens is placed after the mass-transfer printing steps are complete. In a specific implementation of said variation, each row of emitters in the interleave pattern may contain emitters with a unique wavelength such that the wavelengths of the emitters vary monotonically with the row number into which they are placed. In a different variation, one or more emitters with a different wavelength from the other emitters may be placed in the interleave pattern at a specific row and column location within the interleave pattern. In yet another variation, the interleave pattern may be organized with rows that increase monotonically in height where each row of the interleave pattern may contain emitters of a unique wavelength which vary monotonically in row number.

In other embodiments, the devices could be fabricated directly on the silicon; fabricated on a compound semiconductor substrate; or combined with conventional packaging methods such as flip-chip, die-bonding, or wire-bonding. In a preferred embodiment, standoffs 107 are fabricated on the microlens surface and Fiducial marks 153 allow alignment of additional optics (108 in FIG. 2) on top of the microlenses 101. In an alternative embodiment, fiducial marks 153 may allow for the alignment of the microlenses 101 to a substrate 100 upon which the emitters 102 rest.

While the exemplary preferred embodiments of the present invention are described herein with particularity, those skilled in the art will appreciate various changes, additions, and applications other than those specifically mentioned, which are within the spirit of this invention. For example, rather than imprinting or molding lenses, lenses can be formed lithographically though spin-coating and polymer reflow and aligned directly to fiducials for similar alignment accuracy. A variety of polymers, epoxys, photoresists, and UV or heat curable materials can be used for lens creation. An array of fiducials 153 may be used for increased alignment with a minimum of 2 being used to adjust for X-position, Y-position and θ-rotation.

1. A device comprising:
a substrate;
an interleaved array of optical emitters and optical detectors electrically connected to the substrate; and
a microlens array of microlenses disposed above the interleaved array and monolithically integrated to the substrate such that a microlens corresponds to each emitter and each detector;
wherein each row within the interleaved array of optical emitters and optical detectors is populated by optical emitters with a wavelength distinct from the wavelengths of optical emitters in other rows.

2. The device of claim 1, wherein an axis of each microlens is offset from its corresponding optical emitter or optical detector.

3. The device of claim 1 wherein the microlenses within the microlens array have axes that are offset from the optical emitters and optical detectors of the interleaved array such that the offset between each microlens and its corresponding optical emitter or optical detector falls within a fixed range.

4. The device of claim 3, wherein the fixed range is between 4.3 and 4.7 um when a focal length of the microlenses is between 98 and 102 um and wherein a waist of the optical emitters is between 2.5 and 4 um.

5. The device of claim 1 wherein optical emitters within a row have emission wavelengths separated by 8 to 12 nm from emission wavelengths of optical emitters in an adjacent row.

6. The device of claim 1 further comprising standoffs which are manufactured in a wafer level processes, and wherein the standoffs are configured to orient additional optical systems.

7. The device of claim 1, further comprising an array of spatial filters corresponding to detectors in the interleaved array, wherein the detectors have sizes sizes between 20-30 um and the spatial filters have sizes of 30-50 ums.

8. The device of claim 1 wherein the array of microlenses includes standoffs having sizes between 5-10 um, the standoffs configured to assemble a second layer of optics on top.

9. A device for delivering light comprising:
a microlens; and
a VCSEL offset from a center of the microlens;
wherein an output of said device delivers a substantially flat wavefront, with a desired waist size and location, and at a desired angle.

10. The device of claim 9 wherein the offset is between 4.3 and 4.7 um when a focal length of the microlens is between 98 and 102 um and wherein the waist size is between 16 and 14 um.

11. The device of claim 9 wherein the microlens forms a spherical surface.

12. The device of claim 9 wherein the VCSEL comprises a single mode emitter.

13. The device of claim 9, configured such that an output of said device delivers a substantially flat wavefront, with a desired waist size and location, and at a desired angle.

14. The device of claim 13 wherein the VCSELs of the device have wavelengths separated by 8 nm or more.

15. The device of claim 9 wherein the wavefront waist is placed at a vertex of the microlens.

16. The device of claim 9 wherein the wavefront waist is placed 10-20 um behind a vertex of the microlens.

17. The device of claim 9 wherein the microlens has chromatic properties configured to emit multiple wavelengths.

18. The device of claim 17 wherein the chromatic properties of the microlens are further configured to filter out undesired wavelengths.

19. A system for emission of light to and collection of light from an optical system comprising:
two optical emitters and two photodetectors; and
a microlens corresponding to each optical emitter and to each photodetector;
wherein the optical emitters and the photodetectors are offset from their corresponding microlenses.

20. The system of claim 19 wherein offsets are between 4.3 and 4.7 um; and
wherein the microlenses have a focal length between 98 and 102 um; and
wherein waists of beams emitted by said microlenses is between 16 and 14 um.

21. The system of claim 19 wherein the microlenses have a spherical surface.

22. The system of claim 19 wherein the emitters are single mode emitters.

23. The system of claim 19 wherein the emitters emit light with wavelengths separated by 8 or more nm from each other.

24. The system of claim 23 wherein the emitters are operated simultaneously by a transceiver circuit and wherein light from the emitters travels down a single optical fiber.

25. The system of claim 24 wherein light from a second single optical fiber illuminates the photodetectors, and wherein said photodetectors are configured to send electronic signals configured to be received by one or more transceiver circuits.

26. The system of claim 24 further comprising spatial filters located on top of the photodetectors, the spatial filters configured to block undesired light
